(19) United States
(12) Patent Application Publication
(10) Pub. No.: US 2009/0067836 A1
(43) Pub. Date: Mar. 12, 2009

(54) METHOD, APPARATUS, SYSTEM, AND COMPUTER PROGRAM TO VALIDATE NETWORK ELEMENT INTERFACES FOR FUNCTIONAL TESTING

(75) Inventors: David H. Liu, Herndon, VA (US); Guy M. Merritt, Purcellville, VA (US); Keith R. Bennington, Manassas, VA (US)

Correspondence Address: FITZPATRICK CELLA (TELLABS), 30 ROCKEFELLER PLAZA, NEW YORK, NY, 10112-3800, US

(73) Assignee: TELLABS VIENNA, INC., Naperville, IL (US)

(21) Appl. No.: 11/854,297

(22) Filed: Sep. 12, 2007

(51) Int. Cl. H04J 14/00

(52) U.S. Cl. 398/50; 398/45

(57) ABSTRACT

A method, apparatus, computer program, and system for validating network element interfaces for functional testing. The method is comprised of coupling together at least two main interfaces of a plurality of main interfaces of at least one network element and providing a signal to one of the main interfaces via at least one communication path such that the signal propagates through that main interface to at least one other of the main interfaces coupled thereto, and back to the at least one communication path. By virtue of the method, apparatus, system, and computer program for validating network element interfaces for functional testing, the amount of time necessary to validate network element interfaces during functional testing can be reduced.

### BACKGROUND OF THE INVENTION

1. Field of the Invention

The present invention relates generally to the testing of network elements, and, more particularly, to a method, apparatus, system, and computer program for validating the functionality of interfaces of network elements.

2. Description of Related Art

There is a growing demand in the industry to find a solution to transmit voice, data, or video from a headend to a subscriber's premises through a fiber optic network all the way into an individual home or business. Such fiber optic networks generally are referred to as fiber-to-the-home (FTTH), fiber-to-the-premises (FTTP), fiber-to-the-business (FTTB), fiber-to-the-node (FTTN), or fiber-to-the-curb (FTTC) networks and the like, depending on the specific application of interest. Such types of networks are also referred to herein generally as “FTTx networks”.

In a FTTx network, such as the one shown in FIG. 1, equipment at a headend or central office couples the FTTx to external services such as a Public Switched Telephone Network (PSTN) or an external network. Signals received from these services are converted into optical signals and are combined onto a single optical fiber at a plurality of wavelengths, with each wavelength defining a channel within the FTTx network.

In a FTTP network, the optical signals are transmitted through the FTTP network to an optical splitter that splits the optical signals and transmits the individual optical signals over a single optical fiber to a subscriber's premises. At the subscriber's premises, the optical signals are converted into electrical signals using an Optical Network Terminal (ONT). The ONT may split the resultant signals into separate services required by the subscriber such as computer networking (data), telephony and video.

In FTTC and FTTN networks, the optical signal is converted to an electrical signal by either an Optical Network Unit (ONU) (FTTC) or a Remote Terminal (RT) (FTTN), before being provided to a subscriber's premises.

A typical FTTx network often includes one or more Optical Line Terminals (OLTs) which each includes one or more Passive Optical Network (PON) cards. Such a typical network is illustrated in FIG. 1. Each OLT typically is communicatively coupled to one or more ONTs (in the case of a FTTP network), or to one or more Optical Network Units (ONU) (in the case of a FTTC network), via an Optical Distribution Network (ODN). In a FTTP network the ONTs are communicatively coupled to customer premises equipment (CPE) used by end users (e.g., customers or subscribers) of network services. In a FTTC network, the ONU's are communicatively coupled to network terminals (NT), and the NTs are communicatively coupled to CPE. NTs can be, for example, digital subscriber line (DSL) modems, asynchronous DSL (ADSL) modems, very high speed DSL (VDSL) modems, or the like.

In an FTTN network, each OLT typically can be communicatively coupled to one or more RTs. The RTs are communicatively coupled to NTs that are communicatively coupled to CPE.

Generally, a PON is made up of fiber optic cabling, passive splitters and couplers that distribute an optical signal through a branched tree topology such as, for example, an optical distribution network ODN. Each fiber segment is terminated at a connector to make a connection to devices at a customer's premises. An OLT transmits a light signal through the fiber and passive splitters, and distributes the light signal to customers, where it is converted into an electronic format by, for example, an ONT for use by the customer devices, in a FTTP network.

One type of CPE connected to an ONT is an analog telephone. The analog telephone connects to a POTS (plain old telephone service) interface on the ONT via a standard RJ-11 connector or some other means. The capacity of data that can be handled on any one of the POTS interfaces on the ONT is limited to 64 kilobits per second, which is the basic digital signaling rate corresponding to the capacity of one voice frequency equivalent channel and is commonly designated as a DS0. To carry a typical phone call, the audio sound is digitized at an 8 kHz sample rate using 8-bit pulse-code modulation (PCM). Multiple DS0s are multiplexed together on higher capacity circuits. 24 DS0s make up a DS1 signal, which when carried over copper wire, is known as a T1 signal.

An ONT can have multiple failure modes. In some cases ONT malfunctions are catastrophic to communications. For example, one common ONT malfunction causes it to send a continuous light signal (modulated or unmodulated) up the shared fiber of an optical distribution network (ODN). This can make it impossible for the OLT to communicate with any of the ONTs on the ODN. Also, in some cases an ONT emits signs that it is eventually going to fail. Moreover an ONT can also fail due to the inability to provide any one of the services at the customer premises, such a telephone, television, and data.

In a PON system, multiple ONTs transmit data to an OLT using a common optical wavelength and shared fiber optic media. Particularly, all the ONT units share the one upstream fiber to the PON and are configured to communicate with the PON during a predetermined time slot.

Another way an ONT can malfunction is when it sends a light signal up to the OLT at inappropriate times while attempting to establish communications or after having established communications with other ONTs on the ODN. This results in the OLT not being able to communicate with any of the ONTs on the ODN.

Therefore, all ONT hardware coming from the manufacturer must undergo extensive tests to validate the integrity of all hardware components of the ONT, in addition to the ONT's functionality. One such test involves validating POTS (plain old telephone service) hardware components, to ensure proper telephone functionality.

### SUMMARY OF THE INVENTION

The foregoing and other limitations are overcome by a method, apparatus, system, and computer program for validating network element interfaces for functional testing.

According to one example aspect of the invention, the system is a test system comprising at least one network element, the network element comprising a plurality of main interfaces that are communicatively coupled together, and at least one communication path. The path is adapted to be communicatively coupled to at least two of the main interfaces so that a signal provided to one of the main interfaces via the at least one communication path propagates through that interface to at least one other of the interfaces communicatively coupled thereto, and back to the at least one communication path.

According to another example aspect of the invention, the method comprises coupling together at least two main interfaces of a plurality of main interfaces of at least one network element, and providing a signal to one of the main interfaces via at least one communication path such that the signal propagates through that main interface to at least one other of the main interfaces coupled thereto, and back to the at least one communication path. Each main interface comprises, for example, a transmit and receive sub-interface, the transmit sub-interface of at least one main interface being communicatively coupled to the receive sub-interface of at least one other main interface. The main interfaces can be, for example, T1 interfaces or other suitable types of interfaces.

The at least one communication path can be formed at least in part by a cross connect. The method may also include providing the signal from at least one tester to a further network element, and then to the at least one communication path from the further network element. The signal can then be provided to the tester to analyze the signal.

The signal can be, for example, a test tone having a predefined frequency, such as 400 Hz, 1004 Hz, or 2800 Hz. At least one of the network elements can include at least one of an OLT, and ONT, and an ONU.

By virtue of the example method, apparatus, system, and computer program described herein, the amount of time necessary to validate network element interfaces during functional testing can be reduced.

### BRIEF DESCRIPTION OF THE DRAWINGS

FIG. 1 represents a conventional FTTx network.

FIG. 2 is a schematic diagram of an existing test system connected to a network element, such as an ONT.

FIG. 3 is a more detailed schematic diagram of an existing test system connected to a network element, such as an ONT.

FIG. 4 is a schematic diagram of a test system connected to a network element, such as an ONT, according to an example embodiment of the present invention.

FIG. 5 is a schematic diagram of a test system connected to a network element, such as an ONT, according to an example embodiment of the present invention, and can represent a more detailed version of the components of FIG. 4.

FIG. 6 is a schematic diagram of interfaces (e.g., TI) that can be used in an example embodiment of the invention.

FIG. 7 is a schematic diagram of connected interfaces that can be used in an example embodiment of the invention.

FIG. 8 is a schematic diagram of a test system connected to a network element, such as an ONT, according to an example embodiment of the present invention, and can represent a more detailed version of the components of FIG. 5.

FIG. 9 is a flowchart of a method according to an example embodiment of the invention.

FIG. 10 is an illustration of a control panel of a tester that can be used in the test systems shown in FIGS. 2-5 and 8.

Reference numerals that are the same but which appear in different figures represent the same elements, even if those elements are not described with respect to each figure.

### DETAILED DESCRIPTION OF THE INVENTION

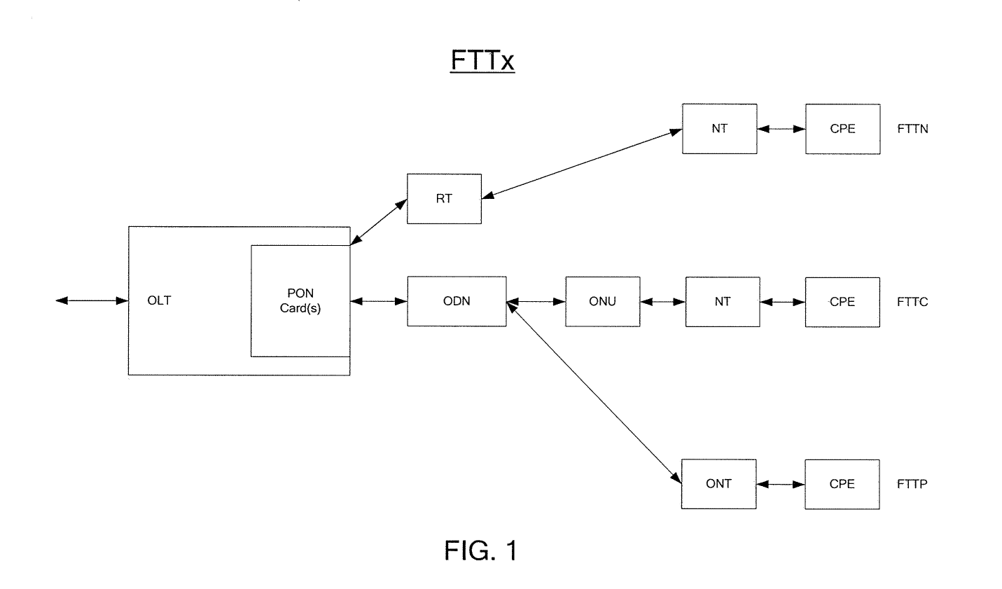

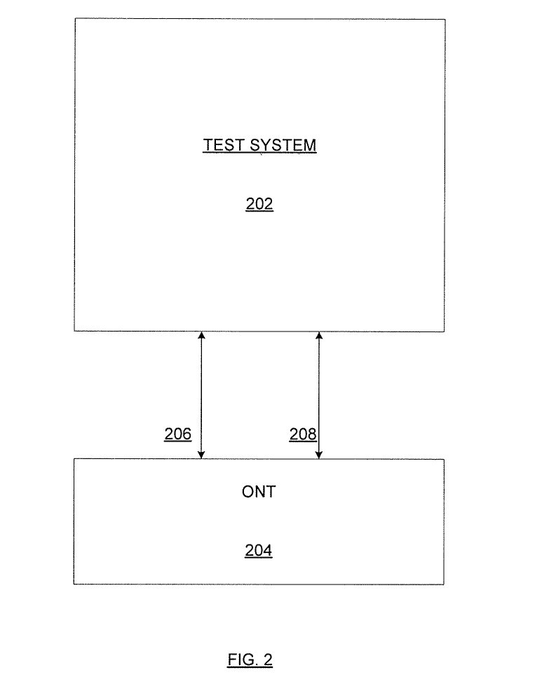

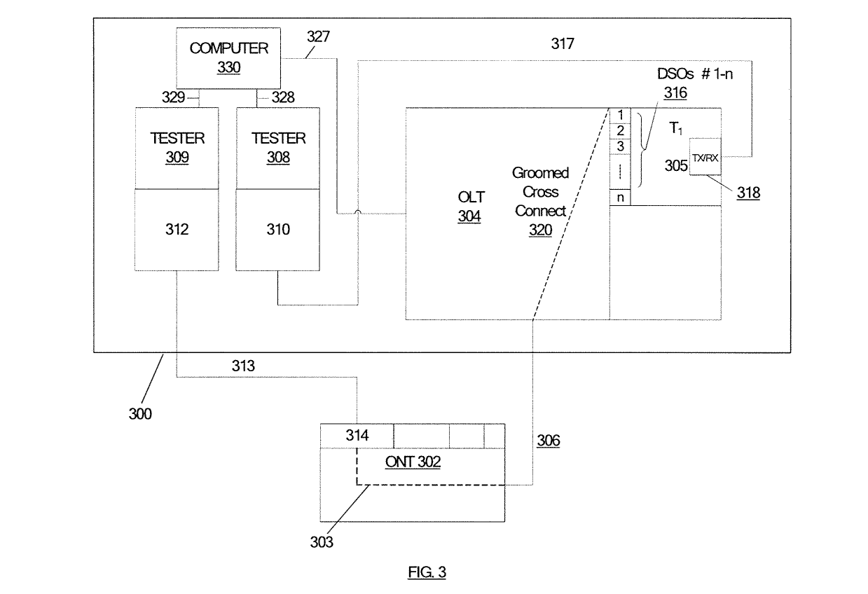

At least one test method employs some of the same components (e.g., an OLT) that would be connected to an ONT when installed in an FTTP network, such as that represented in FIG. 1. A test setup configuration is shown in FIG. 2, where an ONT 204 is connected to a test system 202 using a fiber connection 206 and a POTS connection 208. FIG. 3 shows a more detailed illustration of components of an existing test system. A test system 300 is connected to an ONT 302 across paths 313 and 306. In this configuration the ONT 302 is connected to an OLT 304 via a fiber optic connection 306. The OLT 304 is further connected to a PCM interface 310 of a tester 308 (such as the Sage 935AT), via path 317. In another configuration (not shown) the OLT 304 is not connected to a tester, but is instead connected to a switch simulator (such as the Spirent Abacus) (not shown). From the ONT 302 a so-called groomed cross connect is created between the POTS interface 314 of the ONT 302 and a T1 interface 305, creating a voice path between the POTS interface 314 and one of the DS0s 316 of the T1 interface 305. Lastly, to validate the POTS hardware, the analog interface 312 of tester 309 is connected to the single POTS interface 314 to be tested via path 313. A computer 330 is communicatively coupled to the OLT 304 and to tester 309 and tester 308. In one example computer 330 is communicatively coupled to the OLT 304 via path 327 to provision the groomed cross connect 320 prior to the test (as described below). In another example computer 330 is communicatively coupled to tester 308 and tester 309 to perform certain functions prior to and during the test, including, for example, recording and or processing measurements acquired from tester 309 (transmitted via path 329) and automatically configuring settings of tester 308 (via path 328) and 309.

A groomed cross connect is a logical virtual cross connect that typically is provisioned prior to testing, and which associates a specific ONT interface with a corresponding channel of an OLT interface device to which the ONT is intended to be in communication. The cross connect is “groomed”, or provisioned, by communicating to the OLT using a computing device (e.g., a server or computer 330) executing either a command line interface computer program or an element management system computer program to configure access identification information for each channel of the OLT that will be virtually connected to an ONT interface. The computer programs can also be used to further configure signals between ONT interfaces including, for example, POTS interfaces and Ethernet interfaces. Once the provisioning of the OLT is completed and the ONT is powered up, the ONT ranges (i.e., synchronizes) with the OLT it is in communication with and the signal path(s) configured during provisioning become available for signal transmission between the ONT interface(s) and the specified OLT interface channel(s).

With the test hardware in this configuration the following procedure is performed. First, in the case where two testers 308 and 309 are used to test a single ONT POTS interface (as in FIGS. 2 and 3), the testers (for example, the Sage 935 units) are initially configured for a test. Typically, a first tester 309 that is configured to receive a test signal is initialized or configured by a computer (e.g., a server or computer 330), although the tester can be initialized or configured manually with or without a computer. If the first tester is initialized or configured by a computing device, a computer program executing on the computing device initializes the first tester. A second tester 308 is typically manually operated and performs the task of sending a test signal, although the second tester can be initialized or configured by a computing device instead. A sequence of test signals then commences during which various performance parameters of the ONT POTS functionality are measured and analyzed.

With reference to FIG. 3, a signal is generated by tester 308 and travels from interface 310 to tranceive/receive (TX/RX) interface 318 via path 317. The signal is routed via a provisioned groomed cross connect 320 from a DS0 316 of T1 interface 305. In the example shown in FIG. 3, the groomed cross connect connects DS0#1 to ONT interface 314 based upon the provisioning information stored in the OLT 304. The signal travels from the OLT 304 to the ONT 302 via path 306. The signal is routed in the ONT 302 to ONT interface 314 via path 303 which is based upon the provisioning information received from the OLT 304. The signal propagates to tester interface 312 via path 313. Characteristics of the returned signal can then be measured at the tester 309 to determine if the signal satisfies predetermined quality criteria and the like. The measurement can also be transmitted to computer 330 and stored therein on a computer readable storage medium. Also, a processor of computer 330 can execute a computer program stored on the computer readable storage medium and process the transmitted measurements to analyze the measurements to automatically determine if the signal satisfies predetermined quality criteria and the like.

As can be appreciated, the existing test procedure described above is limited to testing one POTS interface at a time, during the time it takes to test the sequence of the test signals, because only one round-trip signal path is created when the ONT and OLT are connected according to the illustration of FIGS. 2 and 3.

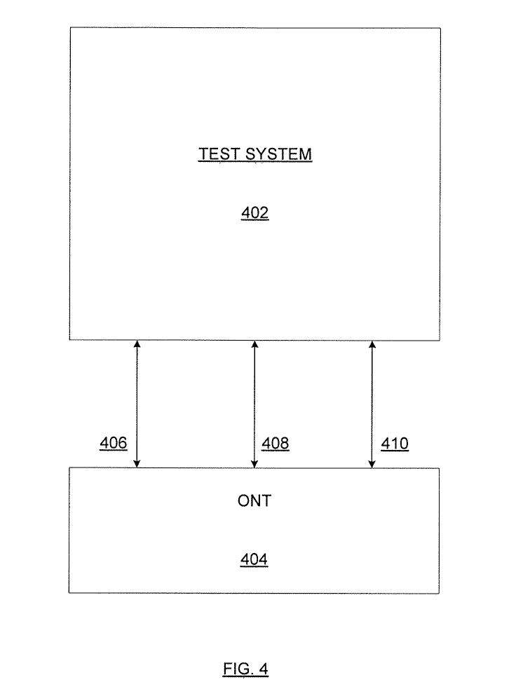

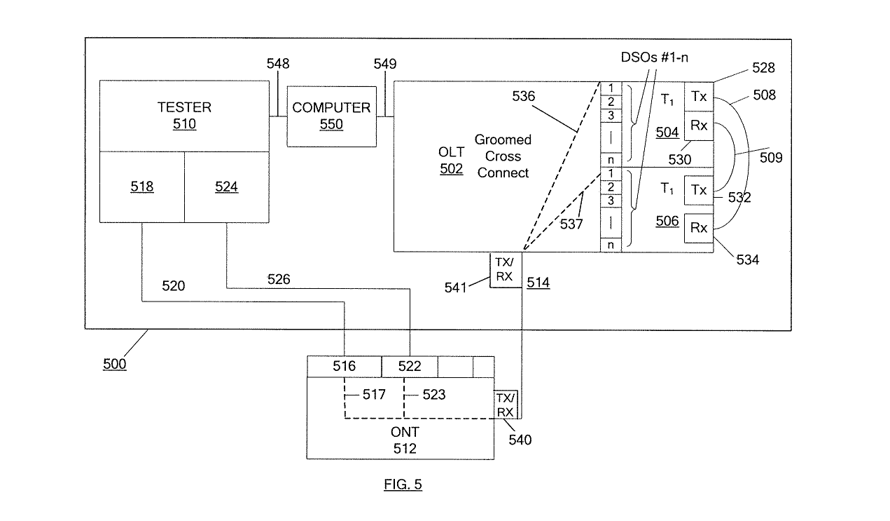

Reference will now be made to FIGS. 4 and 5, which depict a test system and a network element, such as an ONT, according to an example embodiment of the invention. In FIG. 4, test system 402 is communicatively connected to ONT 404 via cable 406 (for example, fiber optic cable), a first POTS line 408, and a second POTS line 410, although other suitable types of interfaces can be used for components 406, 408, and 410 besides those mentioned herein. FIG. 5 provides further detail of the configuration shown in FIG. 4, according to one example embodiment of the invention. In FIG. 5 a network element, such as an OLT 502, includes main interfaces 504 and 506, which in the illustrated example are Ti interfaces. Interface 504 has sub-interfaces such as a transmit (TX) interface 528 and a receive (RX) interface 530, while interface 506 has sub-interfaces such as a transmit interface (TX) 532 and a receive interface (RX) 534. Transmit interface 528 is connected to receive interface 534 by a communication path 508 (e.g., a fiber optic cable). Transmit interface 532 is connected to receive interface 530 by a communication path 509 (e.g., a fiber optic cable). Also in the illustrated embodiment, OLT 502 comprises at least one tranceive (TX/RX) interface 541 bidirectionally coupled to a tranceive (TX/RX) interface 540 of an ONT 512 via path 514. Paths 517 and 523 represent internal paths within ONT 512 that couple interfaces 516 and 522 to interface 540. It should be noted that ONT 512 and OLT 502 can each have more than the number of interfaces shown.

The paths 508 and 509 between interfaces 504 and 506 form a bidirectional signal path (e.g., for voice or data) between DS0s routed through interfaces 504 and 506. For example, a bidirectional signal path is formed between DS0#1 on interface 504 and DS0 #1 on interface 506, between DS0#2 on each interface 504 and 506, and between DS0 #N on each interface 504 and 506, by virtue of the manner in which the interfaces 504 and 506 are interconnected.

At least one tester 510 having interfaces 518 and 524, is connected to interfaces, such as POTS interfaces 516 and 522, on another network element, such as an ONT 512, via communication paths 520 and 526 (e.g., a fiber optic cable), respectively. According to an example embodiment of the invention, tester 510 is configured as a POTS tester (for example, a Sage 935AT) and each interface 518 and 524 is configured as an analog interface. It will be appreciated by those of skill in the art in view of this description that two individual testers, each having a single interface (one equivalent to interface 518 and the other equivalent to interface 524), could be used in place of the single tester 510, or that more than two interfaces 518 and 524 and testers also can be employed.

Groomed cross connects 536 and 537 are formed for POTS interfaces 516 and 522, respectively, so that a signal path is created between POTS interface 516 and DS0 #1 on interface 504 (via paths 517, 514, and 536), and between POTS interface 522 and DS0 #1 on T1 interface 506 (via paths 523, 514, and 537). Similar groomed cross connects also can be provided for interconnecting other ONT interfaces and DS0s of OLT 502, as well.

A groomed cross connect can be formed using a computing device communicatively coupled to the OLT 502. For example, in FIG. 5, a computer 550 is communicatively coupled to OLT 502 and tester 510, and can, among other things, communicate with the OLT 502 via path 549 and with the tester via path 548. The computer can, for example, execute a command line interface computer program or an element management system computer program or the like, stored on a computer readable medium, using a processor coupled thereto, to configure access identification information for each channel of the OLT 502 that will be virtually connected to an interface of the ONT 512. Once the provisioning of the network element (e.g., OLT 502) is completed and another network element (e.g., ONT 512) to which it is communicatively coupled is powered up, the other network element (e.g., ONT 512) synchronizes (i.e. ranges) with the network (e.g., OLT 502) and the signal path(s) configured during provisioning become available for signal transmission between interfaces of the network elements (e.g., the ONT 512 interface(s) and the specified OLT 502 interface channel(s)). In this manner, the groomed cross connects (e.g., 536 and 537) can be formed to provide desired communication paths between ONT 512 and DS0s of OLT 502.

With the ONT 512 connected to test system 500 in this manner, a bidirectional signal path is created between interfaces 518 and 524. The path of a signal transmitted from interface 518 to interface 524 will now be traced as an example of a signal flow. A signal is generated by tester 510 and is transmitted from interface 518. The signal travels through path 520 to POTS interface 516, and then through to the OLT 502 via components 517, 540, 514, and 541. The signal is distributed in the OLT 502 via a groomed cross connect 536 to DS0 #1 of interface 504. Next, the signal is routed from the transmit interface 528 of interface 504 to the receive interface 534 of interface 506. The signal then is routed to DS0 #1 of interface 506. The OLT 502 then routes the signal back to the ONT 512 via groomed cross connect 537, interface 541, and the path 514, such that the signal travels through interface 540, path 523, and POTS interface 522, and then back to the tester interface port 524 via path 526. The signal is then analyzed by the tester 510 in a known manner based on predetermined criteria (e.g., signal quality criteria or the like) to determine if the paths, including the interfaces, traversed by the signal are functioning correctly. It will also be appreciated by one of skill in the art based upon the above description that a signal could travel in a reverse direction, for example by using a tester 510 wherein interface 524 is configured to send a signal and interface 518 is configured to receive a signal.

In performing a test by injecting a signal into one POTS interface (e.g., 516) and analyzing the resultant signal returned from a second POTS interface (e.g., 522), both interfaces can be functionally tested essentially simultaneously (together as a pair in a single test using a same signal), instead of separately using separate tests wherein each POTS interface is tested separately using separate signals.

More particularly, unlike an existing test configuration, such as represented in FIGS. 2 and 3, in the example test system shown in FIG. 5, at least two T1 interfaces 504 and 506 allocated on the OLT 502 are used in a same test instead of only a single T1 interface connected to a tester. The connection between T1 interface 504 and T1 interface 506 creates a signal path that facilitates simultaneous POTS interface testing of a plurality of POTS interfaces (e.g., 516 and 502).

The configuration of test system 500 can be modified for testing other pairs or a different pair of POTS interfaces of a same ONT, such that a plurality of POTS interfaces of a same ONT can be completely tested in pairs. For example, for each pair of POTS interfaces to be tested a corresponding pair of groomed cross connects can be provisioned (if not already provisioned prior to testing one of the POTS interfaces of the pair) to create a signal path between corresponding DS0s of the T1 interfaces 504 and 506 and the pair of POTS interfaces of the ONT 512. Thus, the method, system, apparatus, and program described herein are not limited to testing an ONT with an even number (two or multiples of two) of POTS interfaces, but are applicable to testing any selected number of POTS interfaces. For example, if an ONT has three POTS interfaces 1, 2, and 3, two pairs of interfaces can be sequentially tested in order to completely test all interfaces.

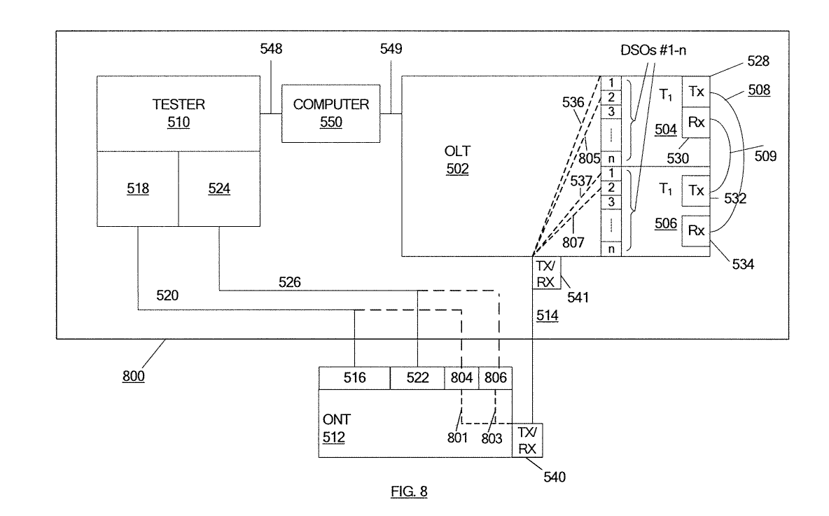

An example of a configuration of a test system 800 for testing an additional pair of POTS interfaces 804 and 806 is shown schematically in FIG. 8. In FIG. 8 an additional pair of groomed cross connects 805 and 807 is provisioned. Groomed cross connect 805 forms a signal path between the POTS interface 804 and DS0 #2 on T1 interface 504 and groomed cross connect 807 forms a signal path between POTS interface 806 and DS0#2 on T1 interface 506. Paths 520 and 526 can be decoupled from POTS interfaces 516 and 522 and re-coupled to POTS interfaces 804 and 806, respectively. Then, testing of interfaces 804 and 806 is performed in the same way as described above for interfaces 516 and 522, but using cross connects 805 and 807. Additional pairs of POTS interfaces of ONT 512 can be tested similarly as described above, by provisioning a pair of groomed cross connects corresponding to the pair of POTS interfaces intended to be tested. As a result one pair of DS0s is allocated for each pair of POTS interfaces to be tested on an ONT. Because a T1 interface typically can only carry N DS0(s) (e.g., N=24), the example embodiments of the invention can be configured to test N pairs of POTS interfaces simultaneously on an ONT. However, additional pairs of T1 interfaces can be introduced to the OLT to expand the number of DS0s and therefore the number of pairs of POTS ports that can be tested according to the principles of the example configuration described above.

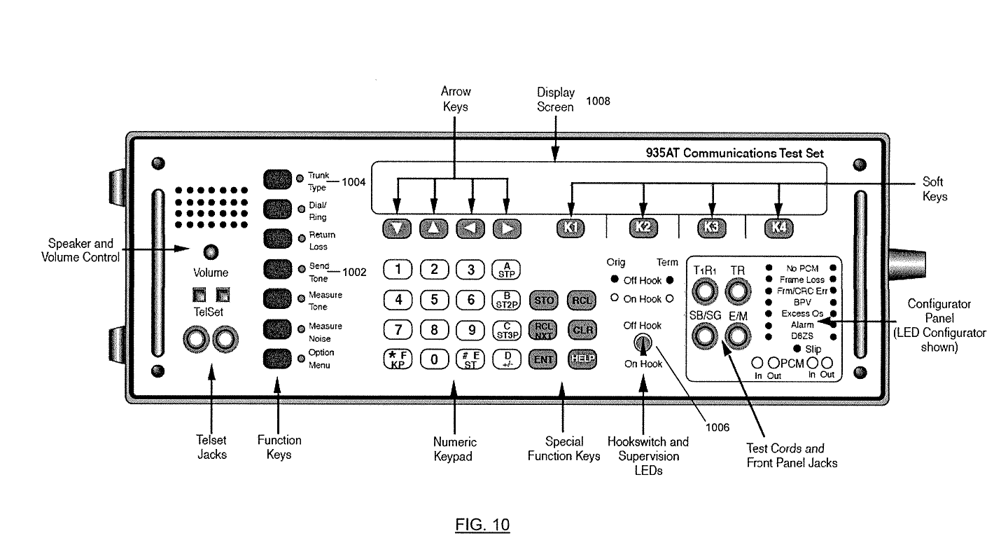

By virtue of the example test configurations of FIGS. 5 and 8, it is not required to connect a pulse code modulation (PCM) interface (e.g., 310 of FIG. 3) of a tester to a T1 resource. Instead, a pair of POTS interfaces of an ONT is connected to corresponding (analog) interfaces of one (or more) testers, such as the Sage 935AT shown in FIG. 10, manufactured by Sage Instruments, of Freedom, Calif. When only a single tester, having at least two analog interfaces, is used, one of the interfaces is configured to transmit a test signal while the other interface is configured to receive the sent test signal. If two or more testers are used in place of a single tester, one (or more) tester(s) can be configured to send a signal and the other (one or more) tester(s) to receive the signal.

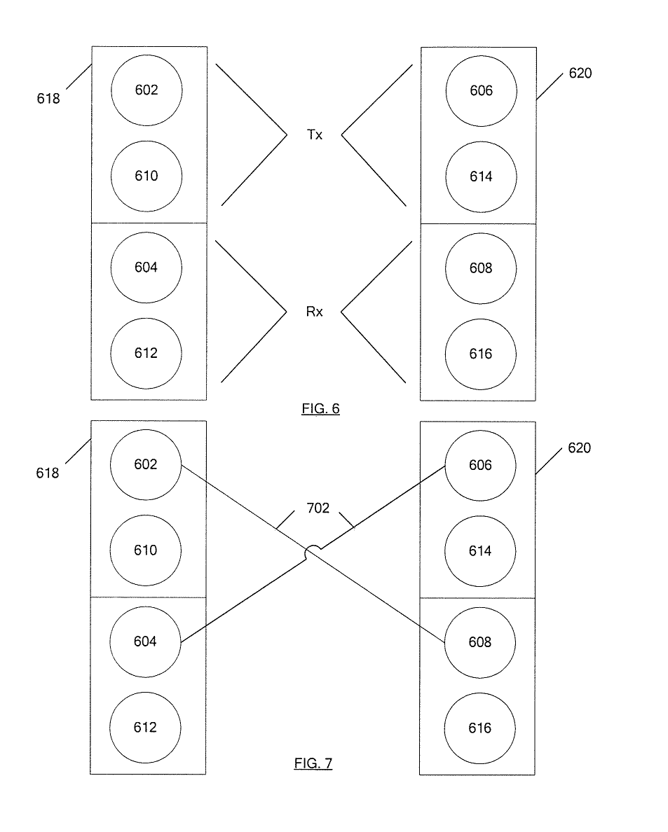

FIG. 6 shows a schematic of T1 interfaces 618 and 620 which can be used in the example embodiments of the test systems shown in FIGS. 5 and 8, such as in OLT 502. T1 interface 618 contains two transmit interfaces 602 and 610 and two receive interfaces 604 and 612. T1 interface 620 contains two transmit interfaces 606 and 614 and two receive interfaces 608 and 616. In FIG. 7 one or more cables (e.g., optical cables) 702 are used to connect transmit interface 602 of T1 interface 618 to the receive interface 608 of T1 interface 620 and to connect transmit interface 606 of T1 interface 620 to the receive interface 604 of T1 interface 618. By virtue of this configuration, signals can be routed between corresponding DS0s in either direction. In other embodiments of the invention, other numbers of T1 interfaces, and other numbers of transmit and receive interfaces therefor, can be provided, in lieu of those depicted.

Because two (or more) POTS interfaces of an ONT can be tested simultaneously using the test system 500 or 800 (of FIG. 5 or 8, respectively) with a test procedure that is substantially similar in duration as that of the pre-existing procedure, it is possible to decrease an average time for testing POTS interfaces, for example, by up to fifty percent. This reduction in test time assumes that the test procedure for testing POTS interfaces simultaneously is substantially similar in duration as that for testing a single POTS interface using the existing test system 300 of FIG. 3.

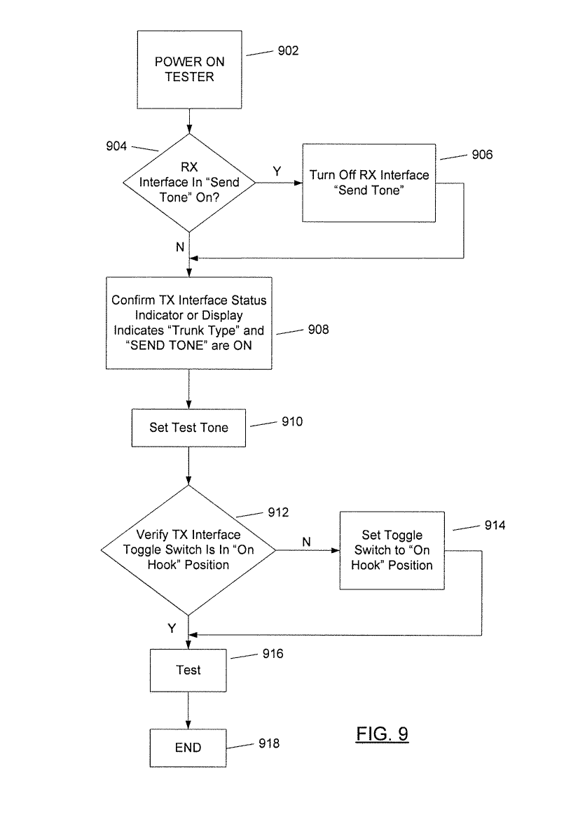

A test procedure according to an example embodiment of the invention will now be described with reference to FIG. 9. With the test system connected to an ONT (e.g., 512), and all system components powered on, the test procedure starts wherein the tester is powered (block 902 of FIG. 9). Next, an indicator or display (e.g., the display screen 1008 or indicator 1002 of FIG. 10), is checked (block 904 of FIG. 9) to determine the status of the interface of the tester allocated as the receive (RX) interface (e.g., 524 of FIGS. 5 and 8). For example, if the receive interface is not in send mode (e.g., indicator 1002 of FIG. 10 not lit) (“No” at block 904) the procedure simply continues to block 908. The interface can be configured to operate in the receive mode, if not operating in that mode already, by operating the tester (902) in a known manner to select that mode. If it is determined at block 904 that the receive interface is in send mode (“Yes” at block 904), the send mode is turned off (block 906 of FIG. 9), for example, by pressing a button or the like, or automatically, and the procedure continues to block 908.

At block 908 a predetermined indicator or display of the tester 902 is viewed to determine whether a second interface of the tester allocated as the transmit (TX) interface (e.g., 518 of FIGS. 5 and 8) is set for a transmit mode, and if the second interface is not operating in the transmit mode, the tester is operated in a known manner to select that mode for the second interface. For example, in either case, the determination can be made by confirming that the “Trunk Type” indicator is on (e.g., indicator 1004 of FIG. 10 is lit) and the “Send Tone” indicator (e.g., indicator 1002 of FIG. 10) is activated (block 908 of FIG. 9). In a communications network, a trunk is a single transmission channel between two points that are switching centers or nodes, or both. Trunks may be used to interconnect switches, such as major, minor, public and private switches, to form networks. “Trunk Type” generally refers to a circuit where a single transmission channel uses the same type of equipment on the transmitting and receiving ends. In the present context of the test process of FIG. 9, the trunk type designation is a configuration setting of the tester such that the tester will expect (and therefore analyze) a returned signal which should be substantially similar to the signal sent by the tester. If the trunk type setting is not properly configured, the test measurements may not be accurate, resulting in a possible incorrect test result (e.g., an incorrect pass/fail designation).

Next, at block 910, a test tone frequency (e.g., frequency of a test tone) is selected, for example, by operating an input interface of the tester. The test tone frequency may include, for example, 400 Hz, 1004 Hz, or 2800 Hz, or another predetermined frequency. Prior to starting a functional test sequence at block 916, the position of a transmit interface toggle switch (e.g., 1006 of FIG. 10) is checked (block 912 of FIG. 9). If the toggle switch is in the “On Hook” position, meaning for example, that the send and receive interfaces of the tester (e.g., 510) are both not transmitting or receiving a signal, the functional test is entered at block 916. Otherwise, the position of toggle switch can be changed to the “On Hook” position (block 914), and the process then proceeds to block 916.

At block 916 of FIG. 9, the functional test sequence begins. One example embodiment of such a test includes transmitting a first signal having the selected tone frequency from a tester 510 interface 518 to at least one interface 516 of a plurality of interfaces of a first network element, such as ONT 512, such that the signal traverses the path described above in connection with, for example, FIG. 5, through another network element, such as OLT 502, and then back through at least another one of the interfaces of the first network element, and to tester interface 524.

An example embodiment of a method of testing also can include analyzing the returned signal, to determine whether the signal indicates an acceptable functional characteristic or quality of the tested interfaces of the first network element. According to one example, this can be performed using a tester 510, such as a Sage 935 AT, which analyzes the returned signal and provides a user-perceptible indication on an output interface of whether the POTS interfaces are functioning acceptably.

The test may be manually performed by a user analyzing the output interface to determine whether the indicator indicates functional acceptability or not. The test may also be automated such that the tester 510 is controlled by a computer, such as, for example, computer 550 of FIGS. 5 and 8 communicatively coupled to tester 510 via path 548, and executing a computer program (i.e. a test script) stored in the computer's computer readable medium. Test measurements acquired during testing may be manually or automatically recorded. For example, test measurements acquired by the tester during the test can be stored on the computer readable medium of the computer (e.g., 550 of FIGS. 5 and 8) or on another computer readable medium separate from the computer. The stored test measurements can then be analyzed and compared against an acceptance criteria to determine if the tested interfaces meet acceptable performance criteria. For example, recorded test measurements can be compared to an acceptance test criteria using an algorithm to identify POTS interfaces (and therefore corresponding ONTs) that are either functionally acceptable or functionally defective, and therefore in need of further troubleshooting.

Another example of a test that can be performed at block 916 is a perceptual speech quality measurement (PSQM) test that results in determining a mean opinion score (MOS) In the PSQM test, the signal used in the test represents a human voice tone or other audible signal. The returned signal received by the tester is then given a MOS score.

PSQM is a computational and modeling algorithm defined in ITU Recommendation ITU-T P.861 that objectively evaluates and quantifies voice quality of voice-band (300-3400 Hz) speech codecs. It may be used to rank the performance of these speech codecs with differing speech input levels, talkers, bit rates and transcodings. The ITU-T has withdrawn P.861 and replaced it with P.862 (PESQ) which contains an improved speech assessment algorithm. PSQM uses a psychoacoustical mathematical modeling (both perceptual and cognitive) algorithm to analyze the pre- and post-transmitted voice signals, yielding a PSQM value which is a measure of signal quality degradation and ranges from 0 (no degradation) to 6.5 (highest degradation). In turn, this result may be translated into a Mean Opinion Score (MOS), which is an accepted measure of the perceived quality of received media on a numeric scale ranging from, for example, 1 to 5. A value of 1 indicates unacceptable, poor quality voice while a value of 5 indicates high voice quality with no perceptible issues. After the test of block 916 is performed, the procedure ends at block 918.

For the purposes of the test process, the components comprising the test system are assumed to be functional and any unacceptable test measurements are caused by the device being tested (e.g., an ONT). An interface of the device being tested can cause poor test results, for example, due to defects in hardware, software, or both. For example, a solder joint defect in the circuitry of the device can cause poor test results. Also, for example, in the case of testing an ONT, if the software provisioned on the ONT is not installed, is installed incorrectly, or if the incorrect software is installed, the test measurements may indicate poor performance of the ONT interfaces.

It should be apparent to one of skill in the art in view of this description that the invention is not limited for use only with respect to testing POTS interfaces of an ONT on a PON network, but also can be used to test any other types of interfaces of any desired type of network elements, whether ONTs, OLTs, ODNs, ONUs or otherwise, and the test system component 502 can be formed by any type of network element besides an OLT, such as an ONT, ONU, ODN, etc. Also, other example interfaces that can be tested can include, for example, ethernet interfaces, ATM interfaces, frame relay interfaces, etc. Also, OLT may comprise OC3, OC12, or Gigabit Ethernet interfaces, and those interfaces can be used as described above with respect to the T1 interfaces in the example embodiments of FIGS. 5 and 8, to conduct the test described herein. This example is not meant to be limiting, but only to illustrate that other similar communication components may lend themselves to similar solutions as those described above with respect to ONT POTS interfaces, and that the invention is not limited to being used in conjunction only with T1 interfaces, POTS interfaces, or any other interfaces mentioned herein, and also is not limited for use with only ONTs and OLTs. Indeed, in other embodiments the invention can be used to conduct similar testing of other type of interfaces of other types of FTTx network elements, depending on the application of interest.

In the foregoing description, the invention is described with reference to specific example embodiments thereof. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software or computer program embodiments of the present invention may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium,” “machine readable medium,” or “computer readable medium” used herein shall include any medium that is capable of storing, encoding, or transmitting a sequence of instructions for execution by the machine or computer and that cause the machine or computer to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive.

What is claimed is:

1. A test system, comprising:
at least one network element, the network element having
a plurality of main interfaces that are communicatively coupled together; and
at least one communication path adapted to be communicatively coupled to at least two of the main interfaces so that a signal provided to one of the main interfaces via the at least one communication path propagates through that interface to at least one other of the interfaces communicatively coupled thereto, and back to the at least one communication path.

2. The system of claim 1, wherein the at least one communication path is formed at least in part by a cross connect.

3. The system of claim 1, wherein the signal is provided to the at least one communication path by a further network element.

4. The system of claim 3, wherein at least one of the network elements includes at least one of an OLT, an ONT, and an ONU.

5. The system of claim 3, wherein the test system further comprises at least one tester that provides the signal to the further network element.

6. The system of claim 5, wherein the further network element is arranged to receive the signal back from the at least one communication path, and to provide it back to the tester.

7. The system of claim 6, wherein the signal is a test tone having a predefined frequency.

8. The system of claim 7, wherein the predefined frequency is one of 400 Hz, 1004 Hz, and 2800 Hz.

9. The system of claim 1, wherein each main interface comprises a transmit and receive sub-interface, the transmit sub-interface of at least one main interface being communicatively coupled to the receive sub-interface of at least one other main interface.

10. The system of claim 1, wherein the main interfaces are T1 interfaces.

11. The system of claim 6, wherein the tester is adapted to analyze the signal provided thereto by the at least one communication path.

12. A test method comprising:
coupling together at least two main interfaces of a plurality of main interfaces of at least one network element; and
providing a signal to one of the main interfaces via at least one communication path such that the signal propagates through that main interface to at least one other of the main interfaces coupled thereto, and back to the at least one communication path.

13. The method of claim 12, wherein the at least one communication path is formed at least in part by a cross connect.

14. The method of claim 12, further comprising providing the signal to the at least one communication path from a further network element.

15. The method of claim 14, wherein at least one of the network elements includes at least one of an OLT, an ONT, and an ONU.

16. The method of claim 14, further comprising providing the signal from at least one tester to the further network element.

17. The method of claim 16, further comprising forwarding the signal provided back to the at least one communication path to the tester by way of the further network element.

18. The method of claim 17, wherein the signal is a test tone having a predefined frequency.

19. The method of claim 17, wherein the predefined frequency is one of 400 Hz, 1004 Hz, and 2800 Hz.

20. The method of claim 12, wherein each main interface comprises a transmit and receive sub-interface, the transmit sub-interface of at least one main interface being communicatively coupled to the receive sub-interface of at least one other main interface.

21. The method of claim 12, wherein the main interfaces are T1 interfaces.

22. The method of claim 17, wherein the tester is adapted to analyze the signal forwarded thereto.
